(19) United States
(12) Patent Application Publication
(10) Pub. No.: US 2024/0075905 A1
(43) Pub. Date: Mar. 7, 2024

(54) WIPER BLADE COATING COMPOSITION COMPRISING FUNCTIONALIZED GRAPHENE HAVING ENHANCED ADHESIVENESS TO RUBBER, AND PREPARATION METHOD THEREOF

(71) Applicant: BESTGRAPHENE CO., LTD, Yeoju-si, Gyeonggi-do (KR)

(72) Inventors: Myeong Gi KIM, Yongin-si, Gyeonggi-do (KR); Seong Min CHIN, Yeoju-si, Gyeonggi-do (KR); Sung Min HONG, Yeoju-si, Gyeonggi-do (KR); Ji Taek OH, Yeoju-si, Gyeonggi-do (KR); Jung Hoon KIM, Pyeongtaek-si, Gyeonggi-do (KR)

(73) Assignee: BESTGRAPHENE CO., LTD, Yeoju-si, Gyeonggi-do (KR)

(21) Appl. No.: 18/270,834

(22) PCT Filed: Mar. 30, 2021
(86) PCT No.: PCT/KR2021/003893

§ 371 Date: Jul. 3, 2023

(51) Int. Cl. B60S 1/38; C09D 1/00; C09D 5/03; C09D 7/20; C09D 7/62

(52) U.S. Cl. CPC B60S 1/38; C09D 1/00; C09D 5/033; C09D 7/20; C09D 7/62

(57) ABSTRACT

The present invention relates to a coating composition which is for a wiper blade and is for forming a coating layer for lowering the coefficient of friction of a wiper blade rubber base on glass, the coating composition including a lubricant additive and a solvent, wherein the lubricant additive is functionalized graphene capable of self-adhesion to the wiper blade rubber base.

### TECHNICAL FIELD

The present invention relates to a coating composition for a wiper blade, the coating composition including functionalized graphene having enhanced adhesiveness to rubber, and a preparation method thereof.

### BACKGROUND ART

Since a wiper is developed by Mary Anderson in 1903, the wiper has currently become an indispensable device of a vehicle.

In the wipers that are currently used in vehicles, a wiper blade rubber base is coupled to the wiper arm.

When snow, rain, or foreign matters are attached to a windshield while a vehicle is driving, the wiper pivots and removes snow, rain, or foreign matters while the wiper blade rubber base is in close contact with the windshield to secure the driver's view. Since the wiper blade rubber base moves in close contact with the windshield, it is necessary to lower the frictional force of the wiper blade rubber base on the windshield. If the frictional force of the wiper blade rubber base on the windshield is too high, not only is noise generated during the operation of the wiper, but the wiper also shakes and does not properly remove snow, rain, or foreign matters.

In order to reduce the frictional force of the wiper blade rubber base on the windshield, conventionally, the surface of the wiper blade rubber base formed of a material such as natural rubber and chlorinated rubber has been treated or an additive has been used.

The surface treatment method is to reduce the coefficient of friction of the wiper blade rubber base by halogenating the surface of the wiper blade rubber base. However, there is a problem that the surface of the halogenated rubber base is cured over time, and during curing, the rubber base does not properly adhere to the windshield, and thus the ability to remove snow, rain, or foreign matters is significantly reduced, and further, noise and vibration are more severely generated.

The method of using an additive achieves a uniform coefficient of friction of the rubber base on glass by using an additive composed of a fluorine-based resin, silicone rubber powder, and a silicone resin. This method has the effect of preventing noise and vibration in the early stages, but there is a problem that the durability is rapidly reduced when the wiper is used for a long period of time.

Since the method of using surface-treatment or an additive for the polymer blade rubber base has the above-described problems, a method of forming a coating layer on the surface of the rubber base by using a coating solution has recently been proposed. The method of forming a coating layer is to form a coating layer on the surface of the blade rubber base with a coating composition including graphite, non-oxidized graphene, etc. The formed coating layer functions as a lubricant layer which reduces the coefficient of friction on glass, thereby reducing noise and vibration. However, low adhesiveness and wiping durability are problems due to problems caused by different materials between rubber and lubricant additives such as graphite and non-oxidized graphene, which impart lubrication to the coating layer. When the amount of the binder in the coating composition is increased to compensate for the low adhesiveness and wiping durability of the lubricant additive to the rubber, there is a problem that the ratio of the lubricant additive is reduced, thereby deteriorating the wiping performance.

In the end, there is a need to develop a coating composition containing a new lubricant additive with excellent adhesiveness to rubber so as to essentially solve these problems.

### DISCLOSURE OF THE INVENTION

### Technical Problem

One object of the present invention is to provide a coating composition for forming a coating layer with functionalized graphene capable of self-adhesion to a rubber base, and a preparation method thereof.

Hereinafter, other objects which are not specified in the present invention will be additionally considered within the scope which can be easily deduced from the following detailed description and effects thereof.

### Technical Solution

According to an aspect of the present invention for solving the above-described problems, there is provided a coating composition which is for a wiper blade, and is for forming a coating layer for lowering a coefficient of friction of a wiper blade rubber base on glass, the coating composition including a lubricant additive and a solvent, wherein the lubricant additive is functionalized graphene capable of self-adhesion to the wiper blade rubber base.

In an embodiment, the coating composition may not contain a binder.

In an embodiment, an amount of the functionalized graphene may be 0.1-1.0 wt %.

In an embodiment, the functionalized graphene may have a functional group A capable of self-adhesion to the wiper blade rubber base, and the functional group A may be at least one selected from the group consisting of an amine group, a silane group, an amide group, an azide group, a urea group, a urethane group, an alkylene group, an epoxide group, an anhydride, and a mercapto group. In this case, the functionalized graphene may include an organic single molecule or polymer bonded to the functional group A, the organic single molecule or polymer may have a functional group B capable of self-adhesion to the wiper blade rubber base, and the functional group B may be at least one selected from the group consisting of an amine group, a silane group, an amide group, an azide group, a urea group, a urethane group, an alkylene group, an epoxide group, an anhydride, and a mercapto group.

In an embodiment, the amount ratio of the organic single molecule or polymer to the functionalized graphene having the functional group A may be 0.05 to 3.0.

In an embodiment, the functionalized graphene may have a 20 degree of 24.7° to 11.046° in an XRD.

According to another aspect of the present invention for solving the above-described problems, there is provided a method of preparing a coating composition for a wiper blade, the method including: (a) preparing an aqueous graphene oxide solution; (b) preparing a first solution in which a first additive for forming a functional group A is dissolved in a first solvent; (c) mixing the aqueous graphene oxide solution with the first solution and then stirring the mixture to react to prepare a functionalized graphene having the functional group A; (d) separating the functionalized graphene having the functional group A through centrifugation, and washing and drying the separated functionalized graphene; and (e) adding the dried functionalized graphene having the functional group A to a main solvent and dispersing the mixture by ultrasonic waves to prepare a functionalized graphene colloid.

In another embodiment, after step (e) is performed, (f) mixing the functionalized graphene colloid with a second solution in which a second additive is dissolved in a second solvent and dispersing the mixture by ultrasonic waves may be further performed, the second additive may be an organic single molecule or polymer including a functional group B, and the organic monomer or polymer in step (f) may be bonded to the functional group A.

### Effects of the Invention

The wiper blade coating composition of the present invention uses functionalized graphene having functional groups capable of self-adhesion as a lubricant additive of the wiper blade coating composition. Since the functionalized graphene is capable of self-adhesion to the wiper blade rubber base, the amount of the binder contained in the coating composition may be minimized or completely excluded. That is, when the coating layer is formed on the wiper blade rubber base by using the functionalized graphene of the present invention, there are effects of achieving both high wiping performance and high durable wiping performance of the wiper.

Although effects are not considered herein, the effects described in this specification and their provisional effects, which are expected by the technical features of the present invention, may be considered as the effects described in this specification.

### BRIEF DESCRIPTION OF THE DRAWINGS

FIG. 1 is a schematic view of functionalized graphene of a first embodiment.

FIG. 2 is a schematic view of functionalized graphene of a second embodiment.

FIG. 3 shows a comparison result of dispersibility of functionalized graphene and non-oxidized graphene.

FIG. 4 is a schematic cross-sectional view of a wiper having a coating layer formed of functionalized graphene of the present invention.

FIG. 5 is a schematic flowchart of a method of preparing a graphene composition of the present invention.

FIG. 6 shows XRD analysis results of Comparative Examples (left, non-oxidized graphene) and Examples (right, functionalized graphene).

FIG. 7 shows evaluation results of the adhesion performance of the coating layers of Comparative Examples and Examples to a wiper blade rubber base.

FIG. 8A is an image obtained by photographing the surface of a wiper blade rubber base without a coating layer with an optical microscope, FIG. 8B is an image obtained by photographing the surface of a wiper blade rubber base having a coating layer of Comparative Example with an optical microscope, and FIG. 8C is an image obtained by photographing the surface of a wiper blade rubber base having a coating layer of Example with an optical microscope.

The attached drawings are presented for purposes of explanation only, and the technical scope of the present invention is not limited thereto.

### MODE FOR CARRYING OUT THE INVENTION

Hereinafter, the configuration of the present invention guided by various embodiments of the present invention and effects resulting from the configuration will be described with reference to the accompanying drawings. In describing the present invention, detailed descriptions of the related well-known functions that are obvious to a person skilled in the art and would unnecessarily obscure the subject of the present invention are omitted.

A wiper blade has a rubber base formed on a portion thereof that is in contact with a windshield to improve adhesion to the windshield. Graphite or MoS₂, which is used as a lubricant additive of a conventional coating composition for a wiper blade, has excellent lubricating performance, but has a problem in that the durable wiping performance of the wiper is low due to no adhesiveness to rubber. The wiper blade continues to rub against the windshield during the operation of a wiper, and during the friction process, the graphite or MoS₂ leaves the surface of the wiper blade rubber base. In addition, general graphene flakes (reduced graphene, non-oxidized graphene, etc.) have a problem that a coating layer is not uniformly formed due to insufficient dispersion stability, and a large amount of binders are used due to insufficient adhesion to rubber, such that lubrication performance is significantly reduced, and thus there is no improvement in durable wiping performance compared to the conventional coating composition using graphite or MoS₂.

The wiper blade coating composition according to an embodiment of the present invention has solved the above-described problems of the related art by using functionalized graphene.

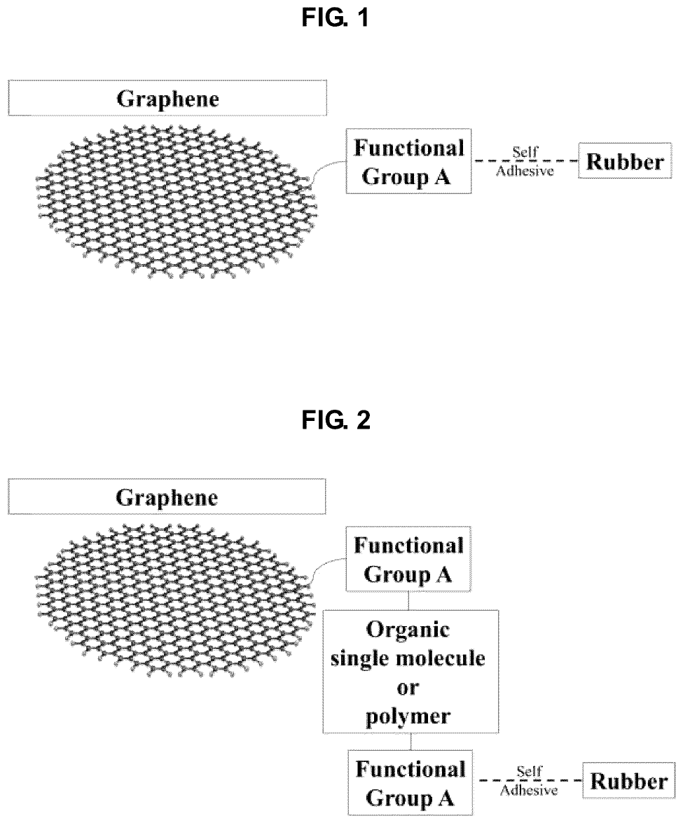

FIG. 1 is a schematic view of the functionalized graphene of the first embodiment, and FIG. 2 is a schematic view of the functionalized graphene of the second embodiment.

The functionalized graphene of the first embodiment has a functional group A capable of self-adhesion to the rubber, and the functionalized graphene of the second embodiment is bonded to an organic single molecule or polymer having a functional group B capable of self-adhesion to the rubber by means of the functional group A. In the second embodiment, the functional group A and the functional group B mean functional groups different from each other.

The rubber base of the wiper blade may be any one selected from the group consisting of natural rubber (NR), styrene butadiene rubber (SBR), nitrile-butadiene rubber (NBR), ethylene propylene diene monomer rubber (EPDM), and silicone rubber. The functional group A or functional group B refers to a functional group having a structure capable of covalently bonding to —OH, —C—O—C—, —C═C—, and —CN groups present on the surface of the rubber base by hydrogen bonding or condensation reaction. That is, the functional group A or functional group B has the advantage that self-adhesion to the rubber base of the wiper blade is possible.

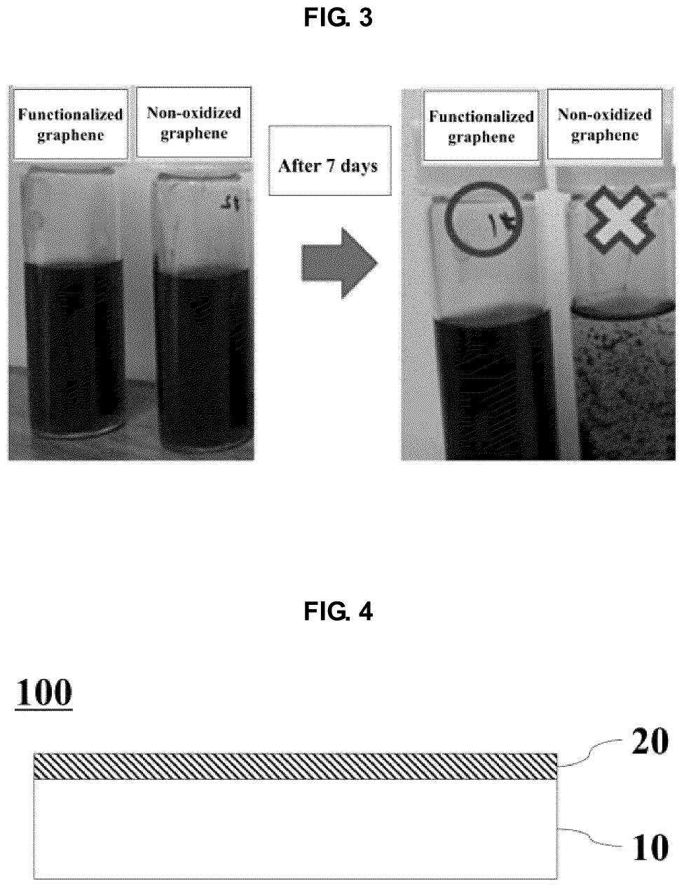

However, graphene has a problem of dispersibility due to a very small size thereof, but the functionalized graphene used in the present invention has significant improved dispersibility by the organic monomer or polymer having the functional group A or functional group B. FIG. 3 shows photographs of the dispersion of the non-oxidized graphene and the functionalized graphene of the present invention in ethanol, and it may be seen that the functionalized graphene of the present invention is well maintained in a dispersed state even after a week, unlike the non-oxidized graphene being agglomerated and precipitated to reduce surface energy.

As described above, the functionalized graphene used in the present invention is capable of self-adhesion to the rubber base by means of the functional group A or functional group B, and also has an effect of improving the dispersibility by means of the functional group A or functional group B.

In the first embodiment, the functional group A may be at least one selected from the group consisting of an amine group, a silane group, an amide group, an azide group, a urea group, a urethane group, an alkylene group, an epoxide group, an anhydride, and a mercapto group.

In the second embodiment, the functional group A may be at least one selected from the group consisting of an amine group, a silane group, an amide group, an azide group, a urea group, a urethane group, an alkylene group, an epoxide group, an anhydride, and a mercapto group, and the functional group B may be at least one selected from the group consisting of an amine group, a silane group, an amide group, an azide group, a urea group, a urethane group, an alkylene group, an epoxide group, an anhydride, and a mercapto group. Meanwhile, the functional group A and the functional group B have different molecular structures, and an organic single molecule or polymer having the functional group B is bonded to the functional group A by hydrogen bonding, ionic bonding, or covalent bonding.

As the organic single molecule or polymer having an amine group, any one selected from the group consisting of ethylenediamine, triethylamine, paraphenylenediamine, 3,3′,4,4′-tetraminobiphenyl, 3,3′,4,4′-tetraminoterphenyl, benzidine, 1,5-diaminonaphthalene, ethylenediamine, 1,6-diaminohexane, 1,8-diaminooctane, 4-aminophenol, and 1,3-nitrophenylamine may be used, but the present invention is not limited thereto. As the organic single molecule or polymer having a silane group, any one selected from the group consisting of polydimethylsiloxane (PDMS), tetramethoxysilane (TMOS), tetraethoxysilane (TEOS), normal triethoxysilane, a dimethyl silicone oil, methylphenyl siloxane, dimethyl siloxane, a diphenyl dimethyl siloxane copolymer, a methylhydrogen silicone oil, SF96, TSF-451, TSF-4420, TSF-4460, TSM-620, TSM-621, TSM-630, TSM-6352, TSM-637, TSM-6341, (3-glycidyloxypropyl)trimethoxysilane (GPTMS), a silane oligomer, or a mixture thereof may be used, but the present invention is not limited thereto. As the organic single molecule or polymer having an amide group, any one selected from the group consisting of Polyamide 6, Polyamide 66, Polyamide 610, Polyamide 12, Polyamide 46, and Polyamide 4 may be used as a polymer linked by —CONH—, which is an amide bond, but the present invention is not limited thereto. As the organic single molecule or polymer having an azide group, any one selected from the group consisting of sodiumazide, 2-azidoethanol, 3-azidopropane-1-amine, 4-(2-azidoethoxy)-4-oxobutanoic acid, 2-azidoethyl-2-bromo-2-methylpropanoate, chlorocarbonate, azidocarbonate, dichlorocarbene, carbene, arene, and nitrene may be used, but the present invention is not limited thereto. As the organic single molecule or polymer having a urea group, polyurea may be used, as the organic single molecule or polymer having a urethane group, polyurethane may be used, and as the organic single molecule or polymer having an alkylene group, any one selected from the group consisting of organic single molecule or polymer having a carbon-carbon double bond may be used, but the present invention is not limited thereto. As the organic single molecule or polymer having an epoxide group, any one selected from the group consisting of BPA, BPF, BP, Novolac (EOCN, OCN, etc.) types of epoxy resins, ethylene oxide, propylene oxide, butene oxide, pentene oxide, hexene oxide, octene oxide, decene oxide, dodecene oxide, tetradecene oxide, hexadecene oxide, octadecene oxide, butadiene monoxide, 1,2-epoxide-7-octene, epifluorohydrin, epichlorohydrin, epibromohydrin, isopropyl glycidyl ether, butyl glycidyl ether, t-butyl glycidyl ether, 2-ethylhexyl glycidyl ether, allyl glycidyl ether, cyclopentene oxide, cyclohexene oxide, cyclooctene oxide, cyclododecene oxide, alpha-pinene oxide, 2,3-epoxy norbornene, limonene oxide, dieldrin, 2,3-epoxypropylbenzene, styrene oxide, phenylpropylene oxide, stilbene oxide, dichlorostilbene oxide, 1,2-epoxy-3-phenoxypropane, benzyloxymethyl oxirane, glycidyl-methylphenyl ether, chlorophenyl-2,3-epoxypropyl ether, epoxypropyl methoxyphenyl ether, biphenyl glycidyl ether, and glycidyl naphthyl ether may be used, but the present invention is not limited thereto. As the organic single molecule or polymer having anhydride, any one selected from the group consisting of acetic anhydride, benzoic anhydride, and maleic anhydride may be used, but the present invention is not limited thereto. As the organic single molecule or polymer having a mercapto group, any one selected from the group consisting of 2-mercaptobenzimidazole, 2,5-dimercapto-1,3,4-thiadizole, and 2-mercaptobenzothiazole may be used, but the present invention is not limited thereto.

In addition, the functionalized graphene of the first embodiment or the second embodiment of the present invention has an interplanar distance of 0.36-0.8 nm. Graphite or the conventional graphene which is not functionalized has an interplanar distance of 0.335 nm, and graphene oxide has an interplanar distance of 0.85-1.25 nm. As the functional group A is introduced or the functional group A-organic single molecule/polymer structure is introduced, the interplanar distance of the functionalized graphene of the present invention becomes 0.36-0.8 nm. That is, the case where the interplanar distance of the functionalized graphene is 0.35 nm or less means that the functional group capable of self-adhesion to the rubber base is insufficient or not present, and when the interplanar distance is greater than 0.8 nm, the wiping performance and durability are deteriorated due to insufficient lubrication performance.

FIG. 4 is a schematic cross-sectional view of a wiper having a coating layer formed of functionalized graphene of the present invention.

A wiper 100 of the present invention includes a wiper blade rubber base 10 and a coating layer 20 formed on the surface thereof. The coating layer 20 serves as a lubricant additive which lowers the coefficient of friction between the wiper blade rubber base 10 and a windshield. The coating layer 20 includes the functionalized graphene of the first embodiment or the functionalized graphene of the second embodiment as described above. The coating layer 20 is formed by the coating composition for a wiper blade of the present invention which will be described later, and the coating composition for a wiper blade of the present invention may have very little binder (0.3 wt % or less) or no binder at all, and a solvent evaporates and disappears during the process of forming the coating layer. Therefore, the coating layer 20 is formed only with the functionalized graphene of the present invention, or formed including the functionalized graphene and a small amount of the binder residue. As described above, the coating layer formed on the surface of the rubber base of the wiper of the present invention has excellent adhesion performance of the functionalized graphene to rubber, and thus the amount of the functionalized graphene that functions as a lubricant with minimizing the amount of binders or without using binders is very high, thereby significantly improving the durable wiping performance of the wiper.

The coating layer formed on the surface of the rubber base of the wiper of the present invention may be formed by the coating composition for a wiper blade.

The coating composition of the present invention includes a lubricant additive and a solvent, and the lubricant additive is a functionalized graphene capable of self-adhesion to a wiper blade rubber base.

The functionalized graphene may be any one or a mixture of the functionalized graphene of the first embodiment and the functionalized graphene of the second embodiment as described above. An amount of the functionalized graphene content may be 0.1-1.0 wt %.

Table 1 below shows the results of measuring coating properties, adhesion, coefficient of friction of the wiper blade, initial wiping performance, and durable wiping performance (100,000 times) according to the amount of functionalized graphene having an amine functional group as the functional group A.

TABLE 1

| Functionalized | | Adhesion | Coefficient | Initial | 100,000 |
|---|---|---|---|---|---|
| graphene content | Coating | (3M tape | of friction | wiping | times wiping |
| (wt. %) | properties | evaluation) | (g/cm) | performance | performance |
| 0.05 | Non-uniform | Insufficient | 0.78 | 8 | 6.8 |
| 0.08 | Non-uniform | Insufficient | 0.65 | 8 | 7.0 |
| 0.1 | Good | Normal | 0.48 | 10 | 8.8 |
| 0.2 | Good | Good | 0.40 | 10 | 8.6 |
| 0.3 | Good | Good | 0.40 | 10 | 8.6 |
| 0.5 | Good | Good | 0.42 | 10 | 8.5 |
| 0.7 | Normal | Good | 0.45 | 10 | 8.0 |
| 1.0 | Normal | Normal | 0.56 | 10 | 7.5 |
| 1.2 | Non-uniform | Insufficient | 0.58 | 10 | 7.0 |
| 1.5 | Non-uniform | Insufficient | 0.55 | 9 | 7.0 |

[Scores of Durable Wiping Performance (Performing based on KS R 3015 durability test)]
10 points: no streaks and wipe marks
9 points: few streaks and wipe marks
8 points: seeing streaks and wipe marks with detailed observation, no effects on driving
7 points: a few streaks and wipe marks, no effects on driving
6 points: streaks wipe marks observed, but no effects on driving
5 points: having effects of streaks and wipe marks on driving
4 points: difficult to drive due to lots of streaks and wipe marks
3 points: very difficult to drive due to lots of streaks and wipe marks
2, 1 points: impossible to secure a front view due to streaks and wipe marks on the entire area of the windshield

When the amount of the functionalized graphene is less than 0.1 wt %, it is difficult to form a continuous graphene coating film having a uniform large area, the adhesion thereof is insufficient, and the coefficient of friction of the wiper blade is higher than 0.6, which is relatively high. In contrast, even when the amount of the functionalized graphene is greater than 1.0 wt %, the thickness of the formed coating layer becomes thick and uneven, and in particular, the cohesion between the functionalized graphenes is greater than the adhesion of the coating layer with the rubber base, such that detachment occurs from the rubber base. Accordingly, there is a problem that adhesion is reduced.

Meanwhile, when the functionalized graphene of the second embodiment is used, the content ratio of the organic single molecules or polymers to the functionalized graphene including the functional group A may be 0.05 to 3. When the content ratio is less than 0.05, the amount of the organic single molecules or polymers is less, and thus there is little improvement in adhesion, and when the content ratio is greater than 3, the adhesion is very high, but the coefficient of friction is increased due to a decrease in lubricating performance, such that chattering (irregular vibration and noise generation due to high friction during the operation of the wiper) occurs during the operation of the wiper and the durability is significantly deteriorated.

Table 2 below shows evaluation results of properties of the functionalized graphene having the functional group A (amine group) according to the amounts of polymers (polyurethane) having the functional group B.

TABLE 2

| | | Adhesion | Coefficient | Initial | 200,000 |
|---|---|---|---|---|---|
| Content | Coating | (3M tape | of friction | wiping | times wiping |
| ratio | properties | evaluation) | (g/cm) | performance | performance |
| 0 | Good | Good | 0.40 | 10 | 8.0 |
| 0.01 | Good | Good | 0.42 | 10 | 8.0 |
| 0.05 | Very good | Very good | 0.45 | 10 | 9.0 |
| 0.1 | Very good | Very good | 0.56 | 10 | 9.5 |
| 0.5 | Very good | Very good | 0.60 | 10 | 9.5 |
| 0.7 | Good | Very good | 0.62 | 10 | 9.2 |
| 1.0 | Good | Excellent | 0.56 | 10 | 9.5 |
| 2.0 | Good | Excellent | 0.60 | 10 | 9.5 |
| 3.0 | Good | Excellent | 0.65 | 9 | 9.0 |
| 3.5 | Good | Very good | 0.88 | 8.5 (Chattering) | 6.8 |
| 4.0 | Good | Excellent | 0.98 | 8 (Chattering) | 6.2 |

When the content ratio of the organic single molecule or polymer to the functionalized graphene including the functional group A is 0.05 to 3, the adhesion is maximized and the durable wiping performance is improved. However, there is a problem in that when the content ratio of the organic single molecule or polymer to the functionalized graphene including the functional group A is greater than 3.0, the adhesion is excellent, but the lubricating performance becomes insufficient, the frictional force is increased, and at the same time, the wiping performance is deteriorated, and thus chattering occurs, such that it is impossible to use the wiper.

As the solvent, only the main solvent may be used, or a sub-solvent may be used together with the main solvent for the purpose of controlling coating properties and a drying process.

The main solvent may be any one selected from among distilled water (DI water), ethanol, and isopropyl alcohol, and the amount thereof may be 93.5-98.9 wt %.

The sub-solvent may be at least one selected from among toluene, methyl ethyl ketone (MEK), dimethylacetamide (DMAc), butyl cellosolve (BC), and butyl cellosolve acetate (BCA), and the amount thereof may be 5 wt % or less.

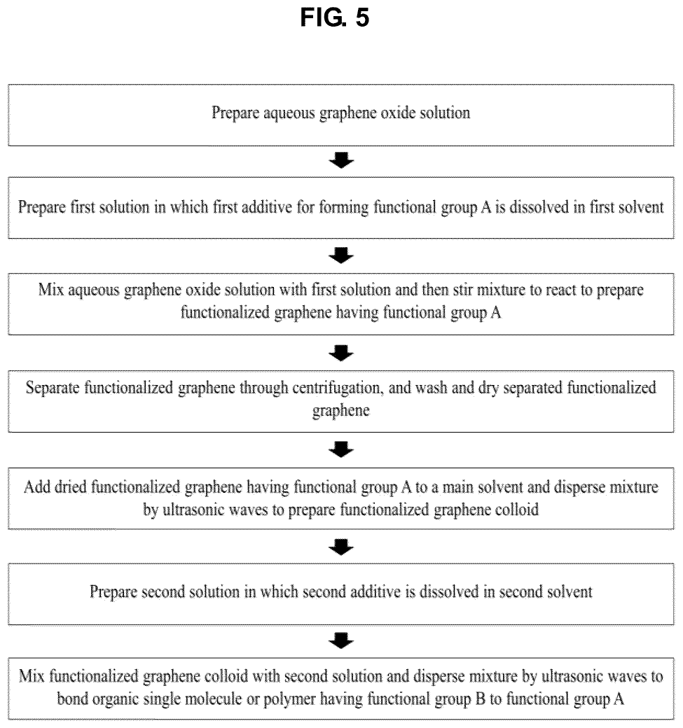

FIG. 5 is a schematic flowchart of a method of preparing a graphene composition of the present invention. A method of preparing the graphene composition of the present invention will be described according to an embodiment.

First, a step of preparing an aqueous graphene oxide solution is performed. The step of preparing the aqueous graphene oxide solution is performed by dispersing 100 mL of an aqueous graphite oxide solution (0.1 wt %) by ultrasonic waves for 4 hours.

Then, a step of preparing a first solution in which a first additive is dissolved in a first solvent is performed. The step of preparing the first solution is performed by dissolving ethylenediamine as the first additive in a dimethylformamide (DMF) solution as the first solution.

Next, a step of mixing an aqueous graphene oxide solution with the first solution, and stirring the mixture to react to prepare a functionalized graphene having a functional group A is performed. The prepared aqueous graphene oxide solution was mixed with the first solution and then reduced and modified at 120° C. for 24 hours while stirring, thereby preparing a functionalized graphene having an amine group as the functional group A.

The prepared functionalized graphene should be separated from the solvent and dried. After the step of preparing the functionalized graphene was completed, the functionalized graphene was separated by centrifugation at 4,000 rpm for 10 minutes. The separated functionalized graphene was added in 1 L of distilled water and washed at 200 rpm for 1 hour. The functionalized graphene was filtered through a filter, and then dried in a vacuum oven at 40° C. for 1 hour.

The dried functionalized graphene was added in a main solvent and dispersed by ultrasonic waves to prepare a functionalized graphene colloid. In this case, the same solvent as the solvent of the coating composition was preferably used as the main solvent. Here, the synthesized functionalized graphene was added again to 100 mL of isopropyl alcohol (IPA), mixed in a homogenizer at 10 k rpm for 10 minutes, and then dispersed by ultrasonic waves for 1 hour to prepare a first functionalized graphene colloid. The first functionalized graphene colloid prepared in this step contains the functionalized graphene of the first embodiment. In case of using the functionalized graphene of the first embodiment, the preparation method is terminated in this step.

In case of using the functionalized graphene of the second embodiment, a step of preparing a second solution in which a second additive is dissolved in a second solvent is further performed. Here, 20 wt % of a PUD aqueous solution (waterborne polyurethane dispersion) was prepared.

Finally, a step of mixing the first functionalized graphene colloid with the second solution and then dispersing the mixture by ultrasonic waves to bond the organic single molecule or polymer having the functional group B to the functional group A is performed. An aqueous solution of functionalized graphene colloid (100 mL) and 0.5 g of the PUD aqueous solution (20 wt %) were mixed, and then dispersed by ultrasonic waves for 1 hour to prepare a second functionalized graphene colloid including the functionalized graphene of the second embodiment.

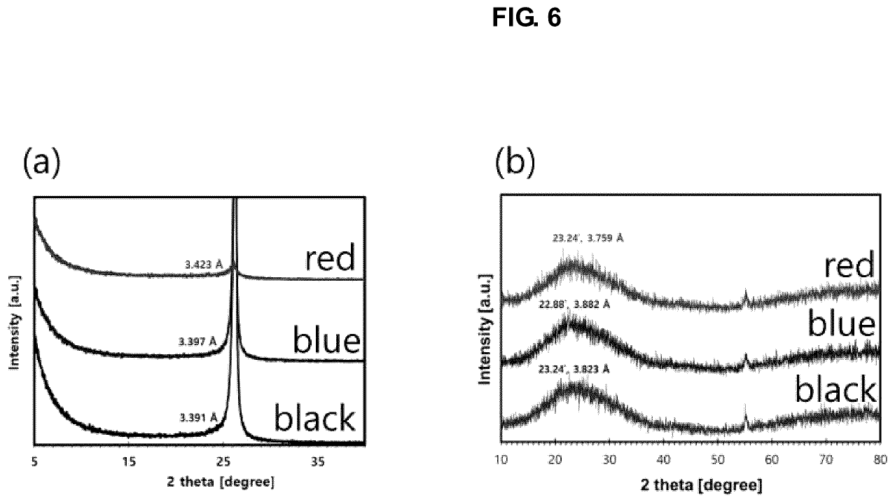

FIG. 6 shows XRD analysis results of Comparative Examples (left, non-oxidized graphene) and Examples (right, functionalized graphene).

The non-oxidized graphene of Comparative Examples is BGF (made by BESEGRAPHENE Co., Ltd.) having a lateral size of 2 um and a thickness of 3-5 nm, and the non-oxidized graphene of Examples is the second functionalized graphene colloid. Referring to FIG. 6, as a result of the XRD measurement, it may be seen that in the case of Comparative Examples, the interplanar distance is 3.391-3.423 Å, which is less than 3.6 Å, but in the case of Examples, the interplanar distance is 3.759-3.882 Å, which is at least 3.6 Å. This is because the interplanar distance of the functionalized graphene increased with the introduction of the organic single molecule or polymer having the functional group A or B. Table 3 below shows evaluation results of the adhesion performance and durable wiping performance of the coating layer after forming the coating layer of the wiper blade rubber base. With respect to the adhesion performance, a 3M tape was attached to and detached from the rubber base, and whether or not damage to the coating layer occurred is marked as O or X, and with respect to the durable wiping performance, the evaluation was performed by scoring with 1 to 10 points based on 200,000 times of wiper pivoting.

TABLE 3

| | | | | 500,000 |
|---|---|---|---|---|
| | XRD 2θ | Interplanar | Adhesion | times wiping |
| Division | degree | distance [Å] | performance | performance |
| Non-oxidized graphene-1 | 26.25 | 3.391 | X | 3.5 |
| Non-oxidized graphene-2 | 26.2 | 3.397 | X | 3.6 |
| Non-oxidized graphene-3 | 26 | 3.423 | X | 3.5 |
| Reduced graphene | 25.5 | 3.489 | X | 3.5 |
| Functionalized graphene-1 | 23.64 | 3.759 | ◯ | 6.0 |
| Functionalized graphene-2 | 22.88 | 3.882 | ◯ | 6.2 |
| Functionalized graphene-3 | 21.5 | 4.128 | ◯ | 6.5 |
| Graphene oxide | 9.2 | 9.601 | X | 4.0 |

Products made by BESTGRAPHENE Co., Ltd. are used as the non-oxidized graphenes 1-3, reduced graphene, and graphene oxide. The functionalized graphene-1 has an ethylamine group as the functional group A in the first embodiment, the functionalized graphene-2 has a phenylamine group as the functional group A in the first embodiment, wherein the length of the functional group A is longer than that of the functionalized graphene-1, and the functionalized graphene-3 has a phenylamine group as the functional group A in the second embodiment, wherein the organic single molecule or polymer linked to the functional group A is urethane. Meanwhile, the interplanar distance of graphene is calculated by XRD analysis and Bragg's equation (Equation 1).

λ=2d·sin(θ) [Equation 1]

When the interplanar distance of graphene is less than 3.6 Å, the adhesion performance is too low. When the interplanar distance of graphene is greater than 8 Å, the improvement in lubricating performance is small. That is, even though the coating layer is formed on the wiper blade rubber base, the coefficient of friction is too large, and thus the durable wiping performance score is lowered to less than 6 points, which has an effect on driving.

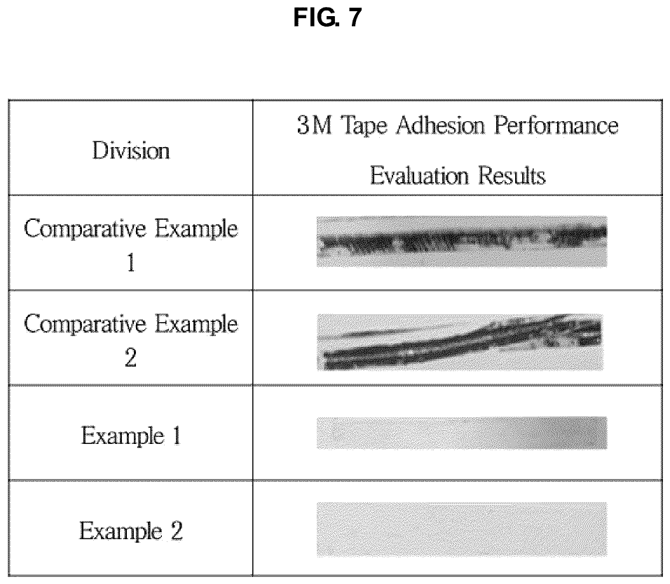

FIG. 7 shows evaluation results of the adhesion performance of the coating layers of Comparative Examples and Examples to a wiper blade rubber base.

In FIG. 7, Comparative Example 1 is a coating layer (commercial product C) formed of a coating composition for a wiper blade of Company C, which is currently commercially available, and Comparative Example 2 is a coating layer (commercial product D) formed of a coating composition for a wiper blade of Company D, which is currently commercially available. Example 1 is a coating layer formed of the coating composition for a wiper blade including the functionalized graphene (functional group A: amine group) according to the first embodiment, and Example 2 is a coating layer formed of the coating composition for a wiper blade including the functionalized graphene (functional group A: amine group, and functional group B: urethane group) according to the second embodiment.

The degrees of the coating layers detached with the 3M tape are compared, and as shown in FIG. 7, Example 2 shows the highest adhesiveness, and Example 1 also shows good adhesiveness. In contrast, in Comparative Examples 1 and 2, when the 3M tape was attached to and detached from the rubber base, the coating layer immediately fell from the rubber base.

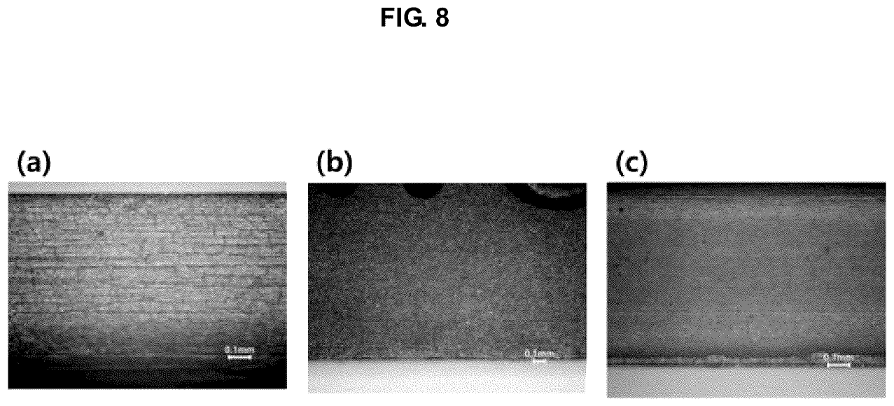

FIG. 8A is an image obtained by photographing the surface of a wiper blade rubber base without a coating layer with an optical microscope, FIG. 8B is an image obtained by photographing the surface of a wiper blade rubber base having a coating layer of Comparative Example with an optical microscope, and FIG. 8C is an image obtained by photographing the surface of a wiper blade rubber base having a coating layer of Example with an optical microscope.

The Comparative Example is the coating layer formed of the coating composition for a wiper blade made by Company D, which is currently commercially available, and uses graphite powder. Seeing the optical photograph of Comparative Example, it is seen that the graphite powder is fixed by a binder.

Example is the coating layer formed of the coating composition for a wiper blade including the functionalized graphene (functional group A: amine group, and functional group B: urethane group) according to the second embodiment. Unlike the Comparative Example, it may be seen that the functionalized graphene is continuously formed in the form of a thin sheet with a large area in the Example.

Next, the coefficient of friction was measured for the purpose of evaluating the lubricating performance of the coating composition of the rubber base for a wiper blade, and the results are shown in Table 4.

TABLE 4

| | | Coefficient | Adhesion |
|---|---|---|---|
| | | of friction | (3M tape |
| Sample | Division | (g/cm) | evaluation) |
| Comparative | Commercial product C | 0.83 | Insufficient |
| Example 1 | | | |
| Comparative | Commercial product D | 0.82 | Insufficient |
| Example 2 | | | |
| Example 1 | Functional group A: | 0.40 | Good |
| | amine group in first | | |
| | embodiment | | |
| Example 2 | Functional group A: | 0.56 | Excellent |
| | amine group in second | | |
| | embodiment | | |
| | Functional group B: | | |
| | urethane group | | |
| Example 3 | Functional Group A: | 0.45 | Good |
| | amine group in second | | |
| | embodiment | | |
| | Functional group B: | | |
| | silane group | | |

Referring to Table 4, it may be seen that the coefficients of friction in Examples 1 to 3 are lower by 0.26-0.43 g/cm than those of Comparative Examples 1 and 2, and thus Examples 1 to 3 have high lubricating performance. When the first embodiment is compared with the second embodiment, it may be seen that the first embodiment has a lower coefficient of friction, and the second embodiment has better adhesion.

Wiping performance was evaluated for Comparative Example 2 and Examples 1 to 3 of Table 4 above. The wiping performance evaluation was performed in the same manner as in Table 1, and the evaluation was performed according to the number of pivoting of the wiper.

TABLE 5

| | | 100,000 | 200,000 | 300,000 | 500,000 |
|---|---|---|---|---|---|
| Division | Initial | times | times | times | times |
| Comparative Example 2 | 9.0 | 7.8 | 7.8 | 6.5 | 3.5 |
| Example 1 | 10.0 | 8.6 | 8.0 | 7.0 | 6.0 |
| Example 2 | 10.0 | 10.0 | 9.5 | 7.8 | 6.5 |
| Example 3 | 10.0 | 9.0 | 9.0 | 7.5 | 6.2 |

Referring to Table 5, it may be seen that all of the Examples have excellent durable wiping performance compared to Comparative Example 2. In particular, in the Examples, the durable wiping performance is maintained up to 200,000 times, and at least 6 points of durable wiping performance scores are obtained even in 500,000 times, so that it may be seen that there is no effect on driving. This seems to be due to the improvement in lubricating performance, adhesion, and abrasion resistance of Examples 1 to 3.

The protected scope of the present invention is not limited to the description and the expression of the embodiments explicitly described above. It is again added that the protected scope of the present invention is not limited by obvious changes or substitutions in the technical field to which the present invention belongs.

<Information on Related National Projects>

Project Number:—
Ministry Name: Ministry of Science and ICT
Research Management Agency: Commercializations Promotion Agency for R&D Outcomes
Program Title: Program for Supporting the Growth of Investment-linked Public Technology Commercialization Enterprises in 2020;
Project Name: Commercialization of Coating Solution Based on Nano-Carbon Composite Material for Improvement in Wiping and Durability of Wiper Blades
Contribution Rate:1/2
Managing Entity: BESTGRAPHENE Co., Ltd.
Research Period: Apr. 1, 2020 to Mar. 31, 2021 (12 months in total)
Project Number: S2940648
Ministry Name: Ministry of SMEs and Startups
Research Management Agency: Korea Technology and Information Promotion Agency for SMEs
Program Title: Demand-Based Technology Transfer
Project Name: Development of Polyimide-Graphene Composite with Heat Resistance, Moisture Resistance, and Heat Dissipation Characteristics for [RFP343] Film
Heaters
Contribution Rate:1/2
Managing Entity: BESTGRAPHENE Co., Ltd.
Research Period: Aug. 1, 2020 to Jul. 31, 2022 (24 months in total)

1. A coating composition which is for a wiper blade and is for forming a coating layer for lowering a coefficient of friction of a wiper blade rubber base on glass, the coating composition comprising:
a lubricant additive; and
a solvent,
wherein the lubricant additive is functionalized graphene capable of self-adhesion to the wiper blade rubber base.

2. The coating composition of claim 1, wherein the coating composition does not comprise a binder.

3. The coating composition of claim 1, wherein an amount of the functionalized graphene is 0.1-1.0 wt %.

4. The coating composition of claim 1, wherein:
the functionalized graphene has a functional group A capable of self-adhesion to the wiper blade rubber base; and
the functional group A is at least one selected from the group consisting of an amine group, a silane group, an amide group, an azide group, a urea group, a urethane group, an alkylene group, an epoxide group, an anhydride, and a mercapto group.

5. The coating composition of claim 4, wherein:
the functionalized graphene comprises an organic single molecule or polymer bonded to the functional group A;
the organic single molecule or polymer has a functional group B capable of self-adhesion to the wiper blade rubber base; and
the functional group B is at least one selected from the group consisting of an amine group, a silane group, an amide group, an azide group, a urea group, a urethane group, an alkylene group, an epoxide group, an anhydride, and a mercapto group.

6. The coating composition of claim 5, wherein the content ratio of the organic single molecule or polymer to the functional group A is 0.05 to 3.

7. The coating composition of claim 1, wherein the functionalized graphene has a 2θ degree of 24.7° to 11.046° in an XRD.

8. A wiper comprising a rubber base and a coating layer formed on the surface of the rubber base, wherein the coating layer is formed of the coating composition of claim 1.

9. A method of preparing a coating composition for a wiper blade, the method comprising:
(a) preparing an aqueous graphene oxide solution;
(b) preparing a first solution in which a first additive for forming a functional group A is dissolved in a first solvent;
(c) mixing the aqueous graphene oxide solution with the first solution and then stirring the mixture to react to prepare a functionalized graphene having the functional group A;
(d) separating the functionalized graphene having the functional group A through centrifugation, and washing and drying the separated functionalized graphene; and
(e) adding the dried functionalized graphene having the functional group A to a main solvent and dispersing the mixture by ultrasonic waves to prepare a functionalized graphene colloid.

10. The coating composition of claim 9, wherein:
after step (e) is performed, (f) mixing the functionalized graphene colloid with a second solution in which a second additive is dissolved in a second solvent and dispersing the mixture by ultrasonic waves is further performed;
the second additive is an organic single molecule or polymer including a functional group B; and
the organic monomer or polymer in step (f) is bonded to the functional group A.
